(19) United States
(12) Patent Application Publication
(10) Pub. No.: US 2015/0145663 A1
(43) Pub. Date: May 28, 2015

(54) SYSTEM FOR TRANSMITTING ACCIDENT DATA AND METHOD THEREOF

(71) Applicant: HYUNDAI MOTOR COMPANY, Seoul (KR)

(72) Inventor: Sang Min MOON, Seoul (KR)

(21) Appl. No.: 14/445,850

(22) Filed: Jul. 29, 2014

(30) Foreign Application Priority Data
Nov. 22, 2013 (KR) 10-2013-0143141

(51) Int. Cl. G07C 5/00

(52) U.S. Cl. CPC G07C 5/008
USPC 340/436

(57) ABSTRACT

A method of transmitting accident data includes transmitting accident occurrence information to a vehicle information center by a vehicle terminal when an accident occurs with a vehicle. Infrastructure information near the location of the accident at the time of the accident is requested by the vehicle information center by transmitting the accident occurrence information to a traffic control center. Upon receiving the infrastructure information from the traffic control center, the infrastructure information is transmitted to a driver registered in advance.

### CROSS-REFERENCE TO RELATED APPLICATION

This application is based on and claims the benefit of priority to Korean Patent Application No.10-2013-0143141, filed on Nov. 22, 2013 in the Korean Intellectual Property Office, the disclosure of which is incorporated herein in its entirety by reference.

### TECHNICAL FIELD

The present disclosure relates to a system for transmitting accident data and a method thereof, and more particularly, to a system for transmitting accident data and a method thereof which can provide accurate data when an accident occurs at an intersection using roadside infrastructure information and a telematics service.

### BACKGROUND

In general, there are traffic signal lights for allowing cars going straight and turning left at intersections. Car accidents occur frequently at the intersections when drivers violate traffic regulations. It is often not clear that at which traffic signal light and from which entry directions cars were driving when the accident occurs. In particular, an inexperienced driver may not accurately understand the accident situation and may fail to obtain evidences, such that he may be in a very disadvantageous situation.

Under the circumstances, recording devices for recording accident situations, such as black boxes, have been developed. However, on busy or dark roads, video from such recording devices may misjudge the situations. Further, drivers have to purchase expensive recording devices out of their own pockets.

### SUMMARY

Accordingly, the present disclosure has been made to solve the above-mentioned problems occurring in the prior art while advantages achieved by the prior art are maintained intact.

An aspect of the present disclosure provides a method for transmitting accident data that provides accurate accident situation evidences to a driver when an accident occurs at an intersection, so that the accident can be resolved amicably and conveniently.

According to an exemplary embodiment of the present disclosure, a method of transmitting accident data includes transmitting accident occurrence information to a vehicle information center by a vehicle terminal when an accident occurs with a vehicle. Infrastructure information near an accident location at the time of the accident is requested by the vehicle information center by transmitting the accident occurrence information to a traffic control center. Upon receiving the infrastructure information from the traffic control center, the infrastructure information may be transmitted to a driver registered in advance.

The traffic control center may periodically collect the infrastructure information from infrastructure near the accident location to store it.

The traffic control center may collect the infrastructure information from the infrastructure near the accident location upon a request from the vehicle information center to store it.

The infrastructure information may include at least one of traffic light information, video information from a closed circuit television (CCTV), and a speed camera.

The step of transmitting the accident occurrence information may include determining if the vehicle enters the intersection, and the vehicle terminal entering an intersection monitoring mode if the vehicle enters the intersection. Location information of the vehicle that entered the intersection and driver information of the vehicle are transmitted to the vehicle information center.

The method may further include releasing the intersection monitoring mode if the vehicle has left the intersection.

The step of requesting the infrastructure information may include the vehicle information center entering a vehicle monitoring mode upon receiving the location information and the driver information of the vehicle from the vehicle terminal. The vehicle monitoring mode is released upon receiving information indicating that the intersection monitoring mode has been released from the vehicle terminal.

The step of transmitting the infrastructure information may include transmitting the infrastructure information to a mobile phone or email of the driver registered with the vehicle information center in advance.

According to another exemplary embodiment of the present disclosure, a system for transmitting accident data includes a vehicle terminal configured to transmit accident occurrence information when an accident has occurred at an intersection. A vehicle information center is configured to request a traffic control center to send infrastructure information near an accident location at the time of the accident to transmit the infrastructure information to a driver using driver information registered in advance upon receiving the accident occurrence information from the vehicle terminal.

The vehicle information center may include a wireless communicator configured to perform wireless communications with the vehicle terminals. A storage is configured to store therein the infrastructure information and the driver information. A controller is configured to receive the infrastructure information from the traffic control center connected thereto and to wirelessly transmit the infrastructure information to a registered driver according to the driver information upon receiving the accident occurrence information from the vehicle terminal.

The vehicle terminal may include a wireless communicator configured to perform wireless communications with the vehicle information center. A location determinator is configured to determine a vehicle location and an accident occurrence detector is configured to detect whether an accident has occurred with the vehicle. A storage is configured to store therein the location information of the vehicle, the accident occurrence information, and the driver information. A controller is configured to enter an intersection monitoring mode if the vehicle enters an intersection based on the location information, to release the intersection monitoring mode if the vehicle has left the intersection, and to transmit the accident occurrence information to the vehicle information center if the accident has occurred.

### BRIEF DESCRIPTION OF THE DRAWINGS

The above and other objects, features and advantages of the present disclosure will be more apparent from the following detailed description taken in conjunction with the accompanying drawings.

FIG. 1 is a block diagram of a system for transmitting accident data according to an embodiment of the present disclosure.

FIG. 2 is a flowchart illustrating a method of transmitting accident data according to an embodiment of the present disclosure.

### DETAILED DESCRIPTION

Hereinafter, embodiments of the present disclosure will be described in detail with reference to the accompanying drawings so that those skilled in the art may easily implement the spirit of the present disclosure.

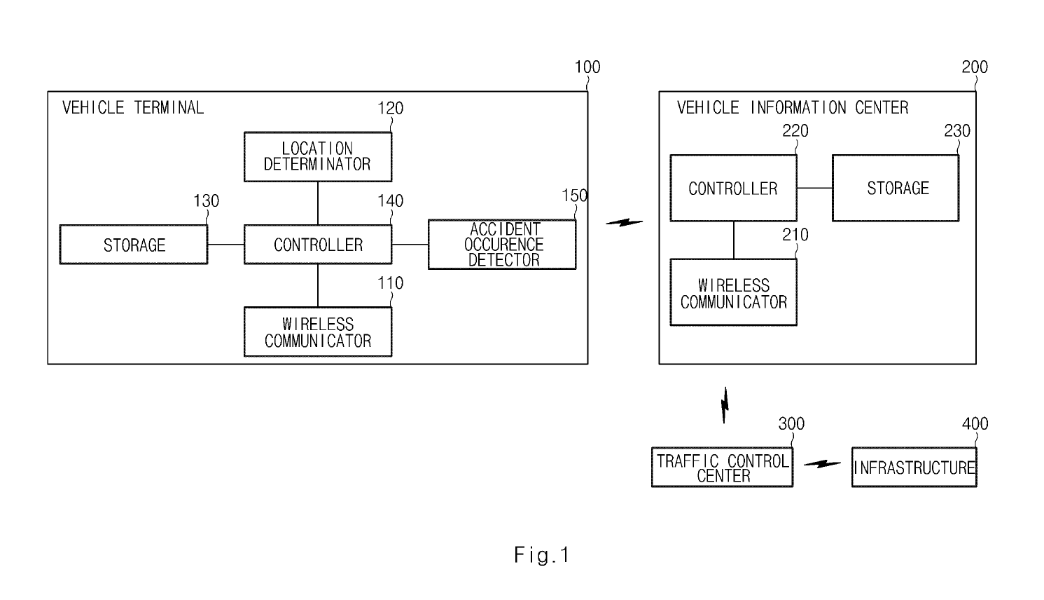

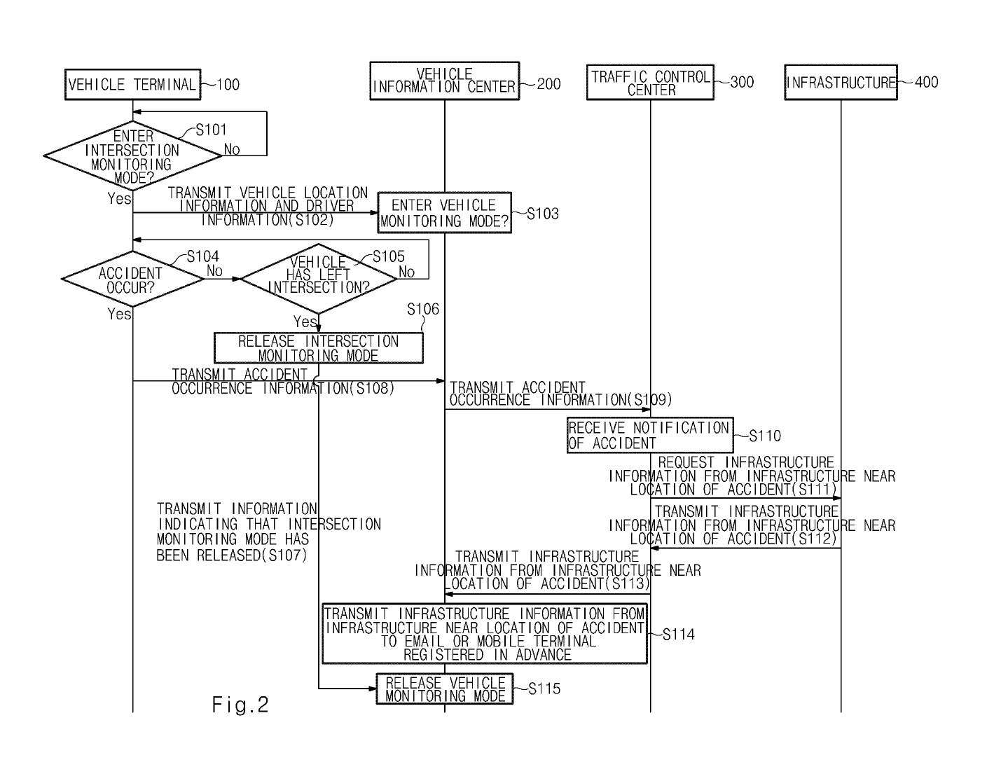

Embodiments of the present disclosure will be described in detail with reference to FIGS. 1 and 2.

FIG. 1 is a block diagram of a system for transmitting accident data according to an embodiment of the present disclosure.

As shown in FIG. 1, the system for transmitting accident data according to an embodiment of the present disclosure may include a vehicle terminal 100, a vehicle information center 200, a traffic control center 300, and an infrastructure 400, which are connected to one another.

If the vehicle terminal 100 senses a traffic accident to transmit accident occurrence information to the vehicle information center 200, then the vehicle information center 200 sends a request for infrastructure information near an accident location at the time of the accident to the traffic control center 300. At this time, the information about infrastructure may contain accident location, information about traffic signal lights, video information from closed circuit televisions (CCTVs), and the like.

To this end, the vehicle terminal 100 may be located in a vehicle and may be a telematics terminal or a navigator.

The vehicle terminal 100 includes a wireless communicator 110, a location determinator 120, a storage 130, a controller 140, and an accident occurrence detector 150.

The wireless communicator 110 performs wireless communications with the vehicle information center 200.

The location determinator 120 determines a current location of the vehicle and may be implemented as a GPS receiver or the like.

The storage 130 may store the vehicle location determined by the location determinator 120, accident occurrence information of a vehicle, driver information of the vehicle, or the like. The accident occurrence information may contain accident time data, accident place (location) data, or the like. The driver information may contain a driver's name, mobile phone information, email information, a vehicle identification number, or the like.

The accident detector 150 may determine that there is an accident if a driver presses a dedicated button, or if a dedicated sensor (not shown) senses that an air bag is deployed and senses the movement of the vehicle. Other techniques to sense an accident known in the art may also be applied.

The controller 140 enters an intersection monitoring mode if the vehicle enters an intersection and exits the intersection monitoring mode if the vehicle exits the intersection, based on the vehicle location information. In addition, if the accident detector 150 detects an accident with the vehicle at the intersection while the controller 140 is in the intersection monitoring mode, the controller 140 controls the accident detector 150 so that it transmits accident data to the vehicle information center 200.

Further, the controller 140 transmits vehicle location and driver information to the vehicle information center 200 when it enters the intersection monitoring mode, and transmits information indicating that the intersection monitoring mode is released to the vehicle information center 200 when it exits the intersection monitoring mode.

The vehicle information center 200 includes a wireless communicator 210, a controller 220 and a storage 230.

The wireless communicator 210 performs wireless communications with the vehicle terminal 100.

The controller 220, upon receiving accident occurrence information from the vehicle terminal 100, is connected to the traffic control center 300 to receive infrastructure information and controls the wireless communicator 210 so that it wirelessly transmits the infrastructure information to drivers based on the driver information registered in advance. The storage 230 stores therein the infrastructure information received from the traffic control center 300 and the driver information registered in advance. The infrastructure information may contain the information from infrastructure installed around intersection and the like, i.e., video information from CCTVs and traffic light information. The registered driver information may contain email addresses, mobile phone numbers and the like, which may be received from the vehicle terminal 100 or may be registered by drivers via wire communications to be stored.

The traffic control center 300 periodically receives infrastructure information from the infrastructure 400 to store it. The traffic control center 300 may collect the infrastructure information at a predetermined time interval or may collect upon a request from the vehicle information center 200.

The infrastructure 400 may include facilities installed at intersections under control of the traffic control center 300, such as traffic lights, CCTVs, speed camera, and the like.

As described above, the system for transmitting accident data according to an embodiment of the present disclosure may provide accident data at intersections to drivers accurately and quickly, by virtue of vehicle terminal 100, the vehicle information center 200, the traffic control center 300, and the infrastructure 400, which are wirelessly connected to one another.

A method for transmitting accident data according to an embodiment of the present disclosure will be described in detail with reference to FIG. 2. The vehicle terminal 100 periodically checks location information of the vehicle and enters an intersection monitoring mode when the vehicle enters an intersection (S101).

Once the vehicle terminal enters the intersection monitoring mode, it transmits vehicle location information and driver information to a vehicle information center 200 (S102). Then, the vehicle information center 200 enters a vehicle monitoring mode and monitors accident occurrence received from the vehicle terminal 100 (S103).

Subsequently, the vehicle terminal 100 checks if an accident occurs at the intersection (S104). If no accident occurs there, the vehicle terminal 100 checks if the vehicle leaves the intersection using the location information from the vehicle, and releases the intersection monitoring mode if the vehicle leaves the intersection (S106).

Then, the vehicle terminal 100 transmits information indicating that the intersection monitoring mode is released to the vehicle information center 200 (S107), and the vehicle information center 200 releases the vehicle monitoring mode (S115).

On the other hand, if it is determined that an accident occurs in the checking S104, accident occurrence information is transmitted to the vehicle information center 200 (S108). The accident occurrence information may include accident time data and accident place (location) data. Then, the vehicle information center 200 transmits the accident occurrence information to a traffic control center 300 (S109).

Upon receiving the accident occurrence information, the traffic control center 300 receives the notification of the accident with the vehicle (S110), and requests the infrastructure 400 near the accident location to send infrastructure information at the time of the accident (S111). Subsequently, the infrastructure 400 near the accident location transmits the infrastructure information at the accident time to the traffic control center 300 (S112), and the traffic control center 300 transmits the accident location data and the infrastructure information to the vehicle information center 200 (S113). Although FIG. 2 illustrates an example in which the infrastructure information is collected upon requests from the vehicle information center 200, the present disclosure is not limited thereto. Alternatively, the traffic control center 300 may periodically collect infrastructure information from the infrastructure 400 to store it, and then may retrieve and provide the stored information upon requests from the vehicle information center 200.

The vehicle information center 200 transmits the accident location data and infrastructure information to a driver's email or mobile terminal registered in advance (S114).

The vehicle information center 200 releases the vehicle monitoring mode which is initiated in the entering S103 (S115).

As described above, according to the present disclosure, when an accident occurs at an intersection, accurate situation evidences at the accident time are provided by virtue of the connection between the vehicle terminal, the vehicle information center, the traffic control center, and the roadside infrastructure, such that causes of the accident can be accurately determined and resolved.

Further, according to an exemplary embodiment of the present disclosure, accurate accident situation evidences are provided to a driver when an accident occurs at an intersection, so that the accident can be dealt with amicably and conveniently.

The exemplary embodiments of the present disclosure described above have been provided for illustrative purposes. Therefore, those skilled in the art would conceive various modifications, alterations, substitutions, and additions without departing from the scope and spirit of the present disclosure as defined by the appended claims, and such modifications, alterations, substitutions, and additions are considered to fall within the scope of the present disclosure.

What is claimed is:

1. A method of transmitting accident data, the method comprising:
transmitting, by a vehicle terminal, accident occurrence information to a vehicle information center when an accident occurs with a vehicle;
requesting infrastructure information near an accident location at the time of the accident by transmitting, by the vehicle information center, the accident occurrence information to a traffic control center; and
upon receiving the infrastructure information from the traffic control center, transmitting the infrastructure information to a driver registered in advance.

2. The method according to claim 1, wherein the traffic control center periodically collects the infrastructure information from the infrastructure near the accident location to store it.

3. The method according to claim 1, wherein the traffic control center collects the infrastructure information from the infrastructure near the accident location upon a request from the vehicle information center to store it.

4. The method according to claim 1, wherein the infrastructure information includes at least one of traffic light information, video information from a closed circuit television (CCTV), and a speed camera.

5. The method according to claim 1, wherein the step of transmitting the accident occurrence information includes:
determining if the vehicle enters the intersection;
the vehicle terminal entering an intersection monitoring mode if the vehicle enters the intersection; and
transmitting location information of the vehicle that entered the intersection and driver information of the vehicle to the vehicle information center.

6. The method according to claim 5, further comprising:
releasing the intersection monitoring mode if the vehicle leaves the intersection.

7. The method according to claim 6, wherein the step of requesting the infrastructure information includes:
the vehicle information center entering a vehicle monitoring mode upon receiving the location information and the driver information of the vehicle from the vehicle terminal; and
releasing the vehicle monitoring mode upon receiving information indicating that the intersection monitoring mode is released from the vehicle terminal.

8. The method according to claim 1, wherein the step of transmitting the infrastructure information includes transmitting the infrastructure information to a mobile phone or email of the driver registered with the vehicle information center in advance.

9. A system for transmitting accident data, the system comprising:
a vehicle terminal configured to transmit accident occurrence information when an accident occurs at an intersection; and
a vehicle information center, upon receiving the accident occurrence information from the vehicle terminal, configured to request a traffic control center to send infrastructure information near an accident location at the time of the accident, to transmit the infrastructure information to a driver using driver information registered in advance.

10. The system according to claim 9, wherein the vehicle information center includes:
a wireless communicator configured to perform wireless communications with the vehicle terminal;
a storage configured to store therein the infrastructure information and the driver information; and
a controller, upon receiving the accident occurrence information from the vehicle terminal, configured to receive the infrastructure information from the traffic control center connected thereto, and to transmit wirelessly the infrastructure information to a registered driver according to the driver information.

11. The system of claim 9, wherein the vehicle terminal includes:
a wireless communicator configured to perform wireless communications with the vehicle information center;
a location determinator configured to determine a vehicle location;
an accident occurrence detector configured to detect whether the accident occurs with the vehicle;
a storage configured to store therein the location information of the vehicle, the accident occurrence information, and the driver information; and
a controller configured to enter an intersection monitoring mode if the vehicle enters an intersection based on the location information, to release the intersection monitoring mode if the vehicle leaves the intersection, and to transmit the accident occurrence information to the vehicle information center if the accident occurs.

12. The system according to claim 1, wherein the accident occurrence information includes accident time data, accident place (location) data, or the like.

13. The system according to claim 9, wherein the infrastructure information includes at least one of traffic light information, video information from a closed circuit television (CCTV), and a speed camera.

14. The system according to claim 9, wherein the accident occurrence information includes accident time data, accident place (location) data, or the like.

15. The system according to claim 5, wherein the driver information includes a driver's name, mobile phone information, email information, a vehicle identification number, or the like.

16. The system according to claim 9, wherein the driver information includes a driver's name, mobile phone information, email information, a vehicle identification number, or the like.
